(19) United States
(12) Patent Application Publication
(10) Pub. No.: US 2004/0159989 A1
(43) Pub. Date: Aug. 19, 2004

(54) Tubular rod pneumatic spring

(76) Inventors: Mark M. Rose, Myrtle Beach, SC (US); Jack R. Roach, Florence, SC (US)

Correspondence Address: CARLSON, GASKEY & OLDS, P.C., 400 WEST MAPLE ROAD, SUITE 350, BIRMINGHAM, MI, 48009, US

(21) Appl. No.: 10/366,850

(22) Filed: Feb. 14, 2003

(51) Int. Cl. F16F 5/00

(52) U.S. Cl. 267/64.11

(57) ABSTRACT

A gas spring provides a first chamber that communicates with a piston rod chamber of a hollow piston rod through an internal aperture. A second chamber is separated from the first chamber by a piston mounted to the piston rod. The piston moves within the gas spring body to vary the volume of the first chamber and the second chamber such that the gas spring operates as a counterbalance. A relatively greater volume of gas may be contained within the gas spring as compared to a conventional gas spring which includes a solid rod, as the first chamber and the piston rod chamber operate as a single relatively larger chamber through communication through the internal aperture.

### BACKGROUND OF THE INVENTION

The present invention relates to a damper assembly, and more particularly to a gas spring having a relatively large hollow rod to increase the gas volume.

Biasing members known as pneumatic or gas springs, which for convenience can be referred to as counterbalance links are becoming more and more common in commercial articles, particularly in the automotive industry, but they are being used in many other fields wherever the need is present to provide a counterbalance force for closure units, such as lids, doors and cabinet fronts, and gas spring replacement for mechanical spring fittings is becoming prevalent. In the automotive field, for example, pneumatic springs are used to assist in opening and supporting trunk lids and lift gates. In such applications, the counterbalance spring assemblies are compressed when the lid is closed, and they extend under differential pressure force acting on the piston rod when the lid is opened.

In conventional pneumatic springs, both the extension and compression chambers are pressurized and, therefore, the pressure differential between the cylinder and the atmosphere only acts on the effective cross-section area of the piston rod which lies in a plane 90.degree. to the longitudinal axis of the rod. As a result, and in a majority of applications, a relatively high internal cylinder pressure is required to cause the spring to extend. For example, in automotive applications it is not uncommon for the pneumatic springs to be pressurized to 2000 psi or more. These high operating pressures impose stringent strength requirements on the materials used to fabricate the pneumatic spring components and this adds to the complexity of the manufacturing process.

Life expectancy of current gas springs is limited due to the high pressures required to achieve certain output load values. The seals within the gas spring permeates at a rate that varies with the pressure of the nitrogen gas captured within the device and the physical characteristics of the seal. The higher the pressure, the higher the permeation rate. Permeation, allowing the gas to escape to the atmosphere, lowers the internal pressure of the device and causes the output load characteristic to drop. This causes a defective part over time.

Accordingly, it is desirable to provide a gas spring having a lower charge pressure within the device without reducing the output load characteristics.

### SUMMARY OF THE INVENTION

The gas spring assembly according to the present invention provides a first chamber that communicates with a piston rod chamber of a hollow piston rod through an internal aperture. A second chamber is sealed from the first chamber by a piston mounted to the piston rod. The piston moves within the gas spring body to vary the volume of the first chamber and the second chamber such that the gas spring operates as a counterbalance.

A relatively greater volume of gas is contained within the gas spring as compared to a conventional gas spring which includes a solid rod. That is, the first chamber and the piston rod chamber operate as a single, relatively larger chamber through communication therebetween.

Applicant has determined that for a conventional gas spring with a solid rod of a diameter of 0.250 inches with a required load output of 100 lbf (445N), the required charge pressure would be 2037 psig. For an equivalent gas spring designed according to the present invention where the hollow piston rod diameter is 0.500 inches, the required charge pressure would be only 509 psig. This is a substantial pressure drop. Moreover, as a larger volume of charge gas is provided, any permeation that may exist will have a much smaller effect on the output force of the gas spring. Lower pressure and higher volume gas enhances the life span of the gas spring. Furthermore, the larger piston rod allows the seals to be relatively smaller in cross-section which further lowers permeation rates and enhances life.

The present invention therefore provides a gas spring having a lower charge pressure within the device without reducing the output load characteristics.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a diagrammatic view of a gas spring installed on a moveable closure member showing the three positions of the counterbalance;

FIG. 2 is a longitudinal section through a gas spring; and

FIG. 3 is a graphical representation of the spring rate of the gas spring designed according to the present invention and a comparable conventional gas spring.

### DETAILED DESCRIPTION OF THE PREFERRED EMBODIMENT

FIG. 1 illustrates a general view of a gas spring assembly 10 designated as a counterbalance link. The gas spring assembly 10 is illustrated in various positions assumed between the compressed condition and an extended (expansion) condition when the counterbalance is installed on a moveable closure 11 of a vehicle 13 so as to control the pivoting movement of the movable closure member such as the hatchback, the lid of a luggage compartment, or the lid of the engine compartment. The gas spring may, of course, be used in many other applications.

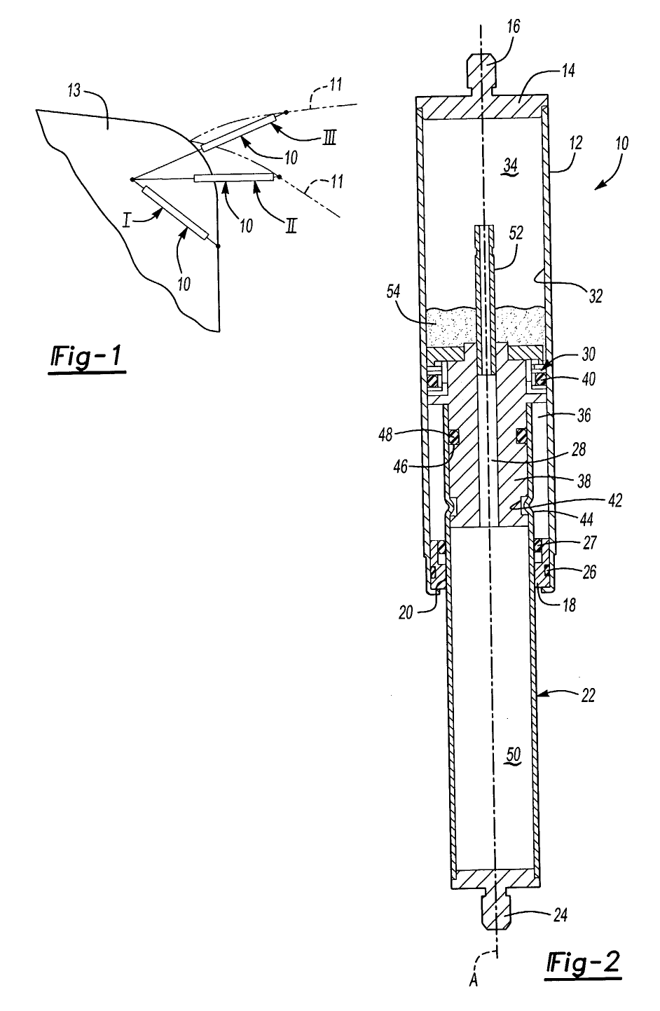

Referring to FIG. 2, a main body 12 of the gas spring is preferably cylindrical. The body 12 has a closed end 14 on which is mounted an attachment fixture (illustrated schematically at 16). The opposite end of the main body 12 is closed off by an end plug 18 which defines an aperture 20 which allow linear passage of a hollow piston rod 22 along gas spring axis A. The piston rod 22 includes an attachment fixture (illustrated schematically at 24). It should be understood that various attachment fixtures such as fixed threaded connections and movable connections such as ball joints will benefit from the present invention.

The end plug 18 includes a seal 26 between the end plug 18 and the body 12 and a seal 27 between the end plug 18 and the piston rod 22. The seals 26, 27 are made of an elastomeric material, such as rubber, and may be one of several geometric shapes. The piston rod 22 slides through the aperture 20 without loss of a gas (e.g., air, nitrogen or some other inert gas) which is contained in both the body 12 and the piston rod 22. That is, the piston rod 22 provides a relatively large volume of gas which communicates between the body 12 and the piston rod 22 through an internal aperture 28.

Within the body 12, the piston rod 22 is attached to a piston 30 which moves engages an inner wall 32 of the body 12 to separate the body 12 into a first chamber 34 and a second chamber 36. The piston 30 operates as a check valve and orifice by-pass structure to provide controlled by-pass flow of gas between chambers 34 and 36. There is a relatively free flow by-pass provided during the retraction or compression stroke and an “orifice” metered flow of gas past the piston during the extension or expansion stroke. It should be understood that piston 30 may include various well-known porting, passageway and/or valve arrangements which provide for pressure transfer between chambers 34 and 36 as the piston rod 22 telescopes inward and outward relative to the body 12.

Preferably, the piston 30 is formed at least in part from a cylindrical plug 38 which forms aperture 28 and provides a rigid support for the piston rod 22 and a seal 40. Plug 38 includes a groove 42 such that piston rod 22 may be mounted to the plug 38 through a crimp 44 which engages the groove 42. A second groove 46 retains a seal 48 to assure a gas tight fit between the plug 38 and the piston rod 22. It should be understood that various plug and piston arrangements will benefit from the present invention.

The first chamber 34 communicates with a piston rod chamber 50 of the piston rod 22 through the internal aperture 28. A relatively greater volume of gas may be contained within the gas spring 10 as compared to a conventional gas spring which includes a solid rod. That is, the first chamber 34 and the piston rod chamber 50 operate as a single relatively larger chamber through communication through the internal aperture 28. The second chamber 36 is separated from the first chamber 34 and the piston rod chamber 50 of the piston rod 22 by the piston 30.

As known, the output force of a gas spring is calculated based on the outside diameter of the rod:

Force=Pressure×Area

Where output Force may be in lbf (pounds force);

Where internal pressure may be in psig (pounds per square inch, gauge); and

Where the Area for the rod may be in in² (inches squared).

Applicant has determined that for a conventional gas spring with as solid rod of a diameter of 0.250 inches with a required load output of 100 lbf (445N), the required charge pressure would be 2037 psig. For an equivalent gas spring designed according to the present invention where the hollow piston rod diameter is 0.500 inches, the required charge pressure would be only 509 psig. This is a substantial pressure drop. Moreover, as a larger volume of charge gas is provided any permeation that may exist will have a much smaller effect on the output force of the gas spring 10. Lower pressure and higher volume gas enhances the life span of the gas spring. Furthermore, the larger piston rod 22 allows seal 27 to be relatively smaller seal in cross-section which results in lower permeation rates and therefore enhances life.

The internal aperture 28 preferably mounts a tubular member 52. The tubular member 52 extends along the gas spring axis A to prevent a liquid oil 54 contained within the first chamber 34 from entering the piston rod chamber 50 of the piston rod 22 when the piston rod 22 is rotated to a downward position as illustrated in FIG. 2. A predetermined quantity of the liquid oil 54 is contained within the first chamber 34 prior to assembly to provides lubrication for the seals 27 and 40 and provides liquid for damping at the end of the expansion stroke as generally known.

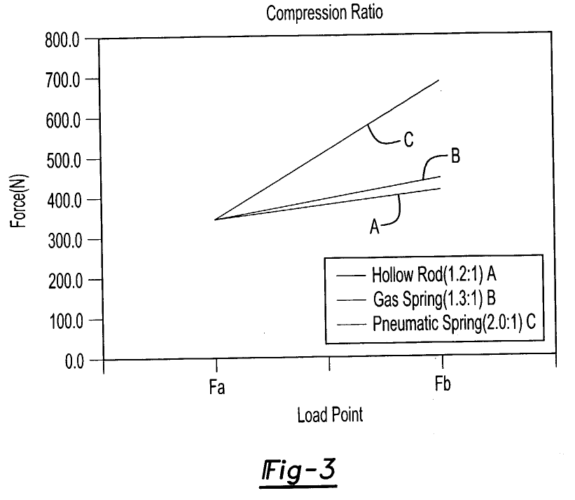

The spring force of the gas spring 10 changes as the piston rod 22 is telescoped into the body 12. A conventional gas spring with as solid rod will have a greater spring rate curve than the gas spring 10 designed according to the present invention (FIG. 3). In addition to the lower gas pressure, the present invention also advantageously provides the flatter slope.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention maybe practiced otherwise than as specifically described. For that reason the following claims should be studied to determine the true scope and content of this invention.

What is claimed is:

1. An pneumatic spring, comprising:
a body;
a hollow piston rod comprising a piston rod chamber; and
a piston mounted to said hollow piston rod, said piston slidably mounted within said body and dividing said body into a first chamber and a second chamber varying in volume in response to a position of said piston, said piston rod chamber in communication with said first chamber.

2. The pneumatic spring as recited in claim 1, wherein said piston comprises a plug portion at least partially mounted within said hollow piston rod.

3. The pneumatic spring as recited in claim 2, wherein said plug portion comprises a internal aperture providing communication between said piston rod chamber and said first chamber.

4. The pneumatic spring as recited in claim 3, further comprising a tubular member extended from said internal aperture, said tubular member extending into said first chamber.

5. The pneumatic spring as recited in claim 1, wherein said body comprises a cylindrical member.

6. The pneumatic spring as recited in claim 1, wherein said hollow piston rod comprises a cylindrical member.

7. The pneumatic spring as recited in claim 1, further comprising an inert gas and a liquid contained within said first chamber.

8. The pneumatic spring as recited in claim 1, wherein said piston allows gas and oil to move between said first chamber and said second chamber to control extension and retraction speed of aid hollow piston rod.

9. A method of providing a fluid communication path within a pneumatic spring to increase a gas volume thereof comprising the steps of:
(a) providing an internal communication path between fixed volume piston rod chamber within a hollow piston rod and a first chamber, said first chamber varies in volume in response to a position of a piston mounted to said hollow piston rod.

10. A method as recited in claim 9, further comprises maintaining a quantity of a liquid within said first chamber and preventing flow of said liquid into said hollow piston rod chamber.
